(19) United States
(12) Patent Application Publication
(10) Pub. No.: US 2026/0288668 A1
(43) Pub. Date: Sep. 24, 2026

(54) DISK DEVICE, CONTROLLER, AND CONTROL METHOD

(71) Applicants: KABUSHIKI KAISHA TOSHIBA, Kawasaki-shi Kanagawa (JP); TOSHIBA ELECTRONIC DEVICES & STORAGE CORPORATION, Kawasaki-shi Kanagawahi (JP)

(72) Inventor: Keigo SOGABE, Chigasaki Kanagawa (JP)

(73) Assignees: KABUSHIKI KAISHA TOSHIBA, Kawasaki-shi Kanagawa (JP); TOSHIBA ELECTRONIC DEVICES & STORAGE CORPORATION, Kawasaki-shi Kanagawa (JP)

(21) Appl. No.: 19/374,443

(22) Filed: Oct. 30, 2025

(30) Foreign Application Priority Data
Mar. 24, 2025 (JP) 2025-048100

(51) Int. Cl. G06F 13/40; G06F 13/16

(52) U.S. Cl. CPC G06F 13/4068; G06F 13/1678

(57) ABSTRACT

According to one embodiment, a disk device is provided that includes a high frequency device, a bus, and a controller. The bus is connected to the high frequency device. When N is an integer of 2 or more, the bus has an N-bit width. The controller is connected to the high frequency device via the bus. In data to be transferred to the high frequency device via the bus, when the bit values in a first word have the same values, and the bit values in a second word have the same values and are inverted from the bit values of the first word, the controller performs, on the data, conversion by which the bit values of the first word and the bit values of the second word have the Same values. The first word has an N-bit width. The second word is subsequent to the first word. The second word has the N-bit width. The controller transfers the data subjected to the conversion to the high frequency device via the bus.

### CROSS-REFERENCE TO RELATED APPLICATIONS

This application is based upon and claims the benefit of Japanese Patent Application No. 2025-048100, filed on Mar. 24, 2025; the entire contents of which are incorporated herein by reference.

### FIELD

Embodiments described herein relate generally to a disk device a controller, and a control method.

### BACKGROUND

In a disk device including a high frequency device and a controller, the controller and the high frequency device are connected by a bus. In the disk device, it is desirable to suppress electromagnetic interference (EMI).

### BRIEF DESCRIPTION OF THE DRAWINGS

FIG. 1 is a diagram illustrating a configuration of a disk device according to an embodiment;

FIG. 2 is a diagram illustrating a controller, a bus, and a high frequency device according to an embodiment;

FIGS. 3A and 3B are tables schematically illustrating operation of the controller in an embodiment;

FIG. 4 is a flowchart illustrating detailed operation of the controller in an embodiment;

FIG. 5 is a flowchart illustrating detailed operation of the controller in an embodiment;

FIG. 6 is a flowchart illustrating detailed operation of the controller in a first modification of an embodiment;

FIGS. 7A and 7B are tables illustrating a use case of write processing in a second modification of an embodiment;

FIGS. 8A and 8B are tables illustrating the use case of the write processing in the second modification of the embodiment;

FIGS. 9A and 9B are tables illustrating the use case of the write processing in the second modification of the embodiment;

FIGS. 10A and 10B are diagrams illustrating a use case of read processing in a third modification of an embodiment.

### DETAILED DESCRIPTION

In general, according to one embodiment, a disk device is provided that includes a high frequency device, a bus, and a controller. The bus is connected to the high frequency device. When N is an integer of 2 or more, the bus has an N-bit width. The controller is connected to the high frequency device via the bus. In data to be transferred to the high frequency device via the bus, when the bit values in a first word have the same values, and the bit values in a second word have the same values and are inverted from the bit values of the first word, the controller performs, on the data, conversion by which the bit values of the first word and the bit values of the second word have the same values. The first word has an N-bit width. The second word is subsequent to the first word. The second word has the N-bit width. The controller transfers the data subjected to the conversion to the high frequency device via the bus.

Exemplary embodiments of a disk device will be explained below in detail with reference to the accompanying drawings. The present invention is not limited to the following embodiments.

### Embodiments

A disk device according to an embodiment includes a high frequency device and a controller, and the controller and the high frequency device are connected by the bus, but the disk device is devised to suppress electro magnetic interference (EMI).

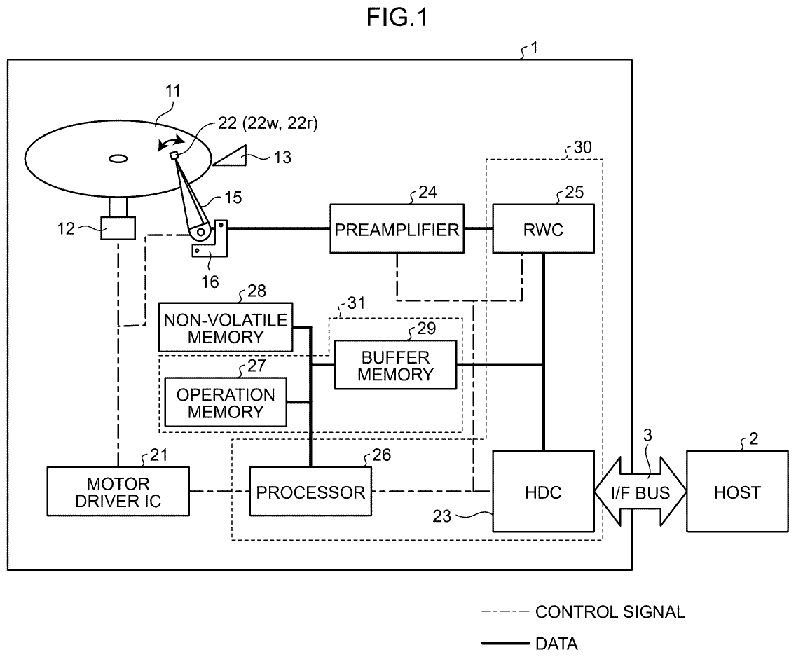

A disk device 1 can be configured as illustrated in FIG. 1. FIG. 1 is a diagram illustrating a configuration of the disk device 1.

The disk device 1 is, for example, a device (e.g., a disk device or a hard disk device) that records information on a disk medium 11 via a head 22 and reads a signal from the disk medium 11 via the head 22. Specifically, the disk device 1 includes the disk medium 11, a spindle motor (SPM) 12, a motor driver 21, the head 22, an actuator arm 15, a voice coil motor (VCM) 16, a preamplifier 24, a read/write channel (RWC) 25, a hard disk controller (HDC) 23, a buffer memory 29, and a processor 26.

The disk medium 11 is a disk-shaped recording medium, and includes, for example, a magnetic disk and a magneto-optical disk. The disk medium 11 is rotated around a rotation axis at a predetermined rotation speed by the SPM 12. The SPM 12 is rotationally driven by the motor driver 21. The disk device 1 may include one or more disk media 11. Hereinafter, a description will be made of the disk device 1 including one disk medium 11, the disk medium 11 being a magnetic disk.

The head 22 is positioned at an end of the actuator arm 15, seeks to a target track along a radial direction (track width direction) of the disk medium 11 by the VCM 16 driven by the motor driver 21, and performs a tracking operation on the target track. For example, when the rotation of the disk medium 11 is stopped, the head 22 is retracted onto the ramp (not illustrated). The head 22 includes a write element 22w and a read element 22r. The disk device 1 may have a plurality of the heads 22 corresponding to the recording surfaces (front and back surfaces) of a plurality of disk media 11, but hereinafter, one disk medium 11 and one head 22 corresponding thereto will be mainly described.

The preamplifier 24 amplifies a signal read from the disk medium 11 by the head 22, outputs the amplified signal, and supplies the signal to the RWC 25. In addition, the preamplifier 24 amplifies a signal for writing data to the disk medium 11, supplied from the RWC 25, and supplies the amplified signal to the head 22.

The HDC 23 performs control of transmission and reception of data to and from a host 2 via an I/F bus 3, control of the buffer memory 29, data error correction for write data, or the like. Furthermore, the buffer memory 29 is used as a cache for data transmitted to and received from the host 2. In addition, the buffer memory 29 is used for temporarily storing data read from the disk medium 11, data written to the disk medium 11, control firmware read from the disk medium 11, or the like.

The RWC 25 performs code modulation on data to be written to the disk medium 11, supplied from the HDC 23, and supplies the data to the preamplifier 24. Furthermore, the RWC 25 performs code demodulation on the signal read from the disk medium 11, supplied via the preamplifier 24, and outputs the signal, as digital data, to the HDC 23.

A section including the RWC 25, the processor 26, and the HDC 23 may constitute a controller 30. The controller 30 may be implemented as, for example, a system on a chip (SoC).

An operation memory 27, a non-volatile memory 28, and the buffer memory 29 for temporary storage are connected to the processor 26.

A section including the operation memory 27 and the buffer memory 29 may constitute a high frequency device 31. The high frequency device 31 may be used at a higher frequency than that of the non-volatile memory 28. The high frequency device 31 may be implemented as, for example, DRAM. The non-volatile memory 28 may be implemented as, for example, a flash memory.

The processor 26 is, for example, CPU or MPU, and performs overall control of the disk device 1, according to firmware stored in advance in the non-volatile memory 28 or the disk medium 11. The firmware includes initial firmware, and the control firmware used for normal operation. The initial firmware executed first upon activation is stored in, for example, the non-volatile memory 28, and the control firmware used for the normal operation is recorded in the disk medium 11. Under the control according to the initial firmware, the control firmware is once read from the disk medium 11 to the buffer memory 29 and then stored in the operation memory 27.

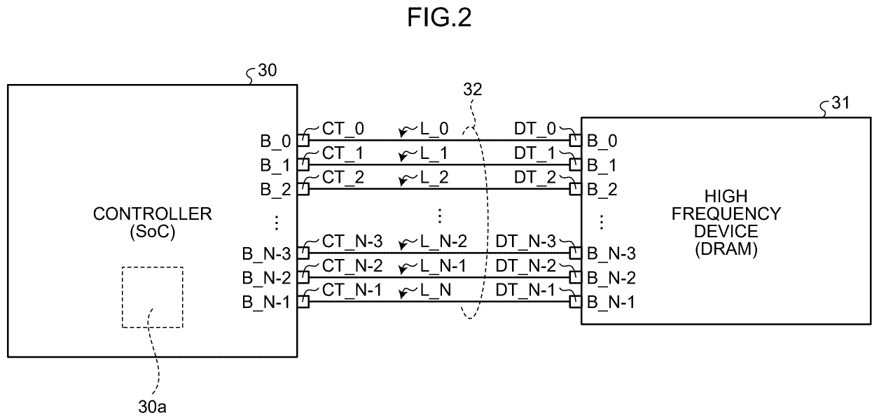

The controller 30 and the high frequency device 31 may be connected via a bus 32 as illustrated in FIG. 2. FIG. 2 is a diagram illustrating the controller 30, the bus 32, and the high frequency device 31.

The bus 32 is a parallel bus. The bus 32 has an N-bit width. N is an integer of 2 or more, For example, N=8, 16, and 32. Hereinafter, N bits will be referred to as one word, and N=16 will be mainly exemplified.

The bus 32 includes N communication lines L_0 to L_N−1. The N communication lines L_0 to L_N−1 are arranged between the controller 30 and the high frequency device 31. Each of the communication lines L_0 to L_N−1 extends from the controller 30 to the high frequency device 31. Each of the communication lines L_0 to L_N−1 has one end that is connected to the controller 30, and the other end that is connected to the high frequency device 31.

The controller 30 includes N terminals CT_0 to CT_N−1. The N terminals CT_0 to CT N−1 function as communication interfaces. The N terminals CT_0 to CT_N−1 correspond to the N communication lines L_0 to L_N−1. To each of the terminals CT, one end of a corresponding communication line L is connected. Therefore, the controller 30 is allowed to collectively transmit a word W including N bits B_0 to B_N−1 to the high frequency device 31 via the bus 32.

The high frequency device 31 includes N terminals DT_0 to DT_N−1. The N terminals DT_0 to DT_N−1 correspond to the N communication lines L_0 to L_N−1. To each of the terminals DT, the other end of a corresponding communication line L is connected. Therefore, the high frequency device 31 is allowed to collectively receive the word W including the N bits B_0 to B_N−1, transmitted from the controller 30, via the bus 32.

The controller 30 handles serial data as data to be transferred to the high frequency device 31. When transferring data to the high frequency device 31, the controller 30 converts the serial data to be transferred into parallel data having an N-bit width. The controller 30 may recognize a start bit in the serial data, identify a delimiter of the word W in the serial data on the basis of a position of the start bit, and generate parallel data having one word width according to a result of identification. The controller 30 supplies the parallel data having the N-bit width (one word width) to the N terminals CT_0 to CT_N−1 in synchronization with a predetermined clock.

Thereby, the parallel data having the N-bit width is collectively transmitted to the high frequency device 31 through the bus 32 having an N-bit width. The high frequency device 31 is a device accessible in units of N bits. The high frequency device 31 may be DRAM accessible in units of 16 bits.

At this time, the bus 32 transmits the parallel data at a relatively high frequency corresponding to an operation frequency of the high frequency device 31. The high frequency device 31 receives the parallel data having the N-bit width, through N terminals DT_0 to DT_N−1 from the bus 32 having the N-bit width, in synchronization with the predetermined clock, and converts the parallel data having the N-bit width into the serial data. The high frequency device 31 internally handles the serial data after conversion.

For example, in some cases, in the data to be transferred, bit values in a word W_A having an N-bit width have the same values, and bit values in a word W_B having the N-bit width, following the word W_A have the same values and inverted from the bit values of the word W_A. In this case, when the word W_A and the word W_B are sequentially transmitted from the controller 30 to the high frequency device 31 via the bus 32 at a relatively high frequency, radio noise (electromagnetic interference (EMI)) emitted from the bus 32 may increase beyond an allowable range.

Therefore, in the embodiment, in the disk device 1, when the bit values in the first word having an N-bit width have the same values and the bit values in the second word having the N-bit width, prior to and adjacent to the first word are inverted from the bit values of the first word, the controller 30 performs conversion by which the bit values of the first word and the bit values of the second word have the same values, thereby suppressing electromagnetic noise. The conversion by which the bit values of the first word and the bit values of the second word have the same values includes inversion of the bit values of the second word.

For example, the controller 30 further includes a conversion circuit 30a illustrated in FIG. 2. When the bit values in the first word having the N-bit width have the same values and the bit values in the second word having the N-bit width, following the first word, have the same values and are inverted from the bit values of the first word, in the data to be transferred to the high frequency device 31 via the N terminals CT_0 to CT_N−1 and the bus 32, the conversion circuit 30a performs conversion, on the data, by which the bit values of the first word and the bit values of the second word have the same values.

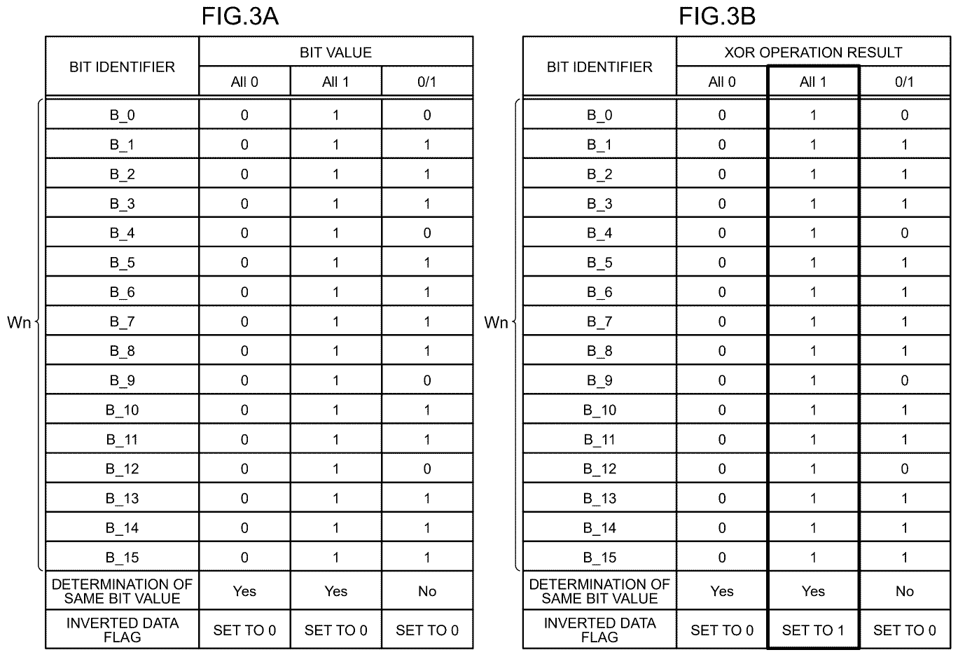

In addition, the controller 30 performs an operation as illustrated in FIGS. 3A and 3B using the conversion circuit 30a. FIGS. 3A and 3B are tables schematically illustrating the operation of the controller 30. In FIGS. 3A and 3B, an n^{th} word is represented by Wn, and an mth bit in the word W is represented by B_m. Each of n and m is an integer of 2 or more.

The controller 30 determines whether the word Wn having the N-bit width which is to be written to the high frequency device 31 from the controller 30 has the same bit value of 0 or 1. In FIGS. 3A and 3B, N=16.

As illustrated in FIG. 3A, when the values (e.g., values of bits B_0 to B_15) of N bits B are all 0, determination of the same bit value is Yes. When the values of the N bits B are all 1, the determination of the same bit value is Yes. When the values of the N bits B are a mixture of 0 and 1, the determination of the same bit value is No. In either case, in the initial state, an inversion data flag is set to be invalid (e.g., 0).

When the determination of the same bit value in the word Wn is Yes, the controller 30 performs an XOR operation with a previous word Wn−1 for each bit.

When any of the N bits (e.g., any of bits B_0 to B_15) has an XOR value of 1, the controller 30 determines that the word Wn is inverted data from the previous word Wn−1, and sets the inversion data flag valid (set to 1).

The controller 30 performs conversion by which each of the bit values of the word Wn and each of the bit values of the word Wn−1 have the same values. The conversion by which each of the bit values of the word Wn and each of the bit values of the word Wn−1 have the same values includes a 0/1 conversion of each bit of the word Wn. The controller 30 inverts each bit value of the word Wn and replaces the word Wn with a word Wn after the inversion to perform the 0/1 conversion on the data. Therefore, in the data, each bit value of the word Wn and each bit value of the previous word Wn−1 have the same values. The controller 30 writes the data subjected to the conversion to the high frequency device 31.

When any of the N bits have an XOR value of 0, the controller 30 maintains the inversion data flag invalid (e.g., 0). The controller 30 does not perform conversion by which the bit values of the word Wn have the same values as the bit values of the word Wn−1, on the word Wn.

When the N-bits have XOR values that are a mixture of 0 and 1, the controller 30 maintains the inversion data flag invalid (e.g., 0). The controller 30 does not perform conversion by which the bit values of the word Wn have the same values as the bit values of the word Wn−1, on the word Wn.

In addition, when the N bits are one word, the controller 30 embeds the inversion data flags for N words in the high frequency device 31, as a word for control.

Thereafter, similar processing is repeated every N+1 words. Therefore, upon reading data from the high frequency device 31, the controller 30 refers to the inversion data flag embedded in the word for control.

The controller 30 keeps the bit values of the word Wn as it is if the inversion data flag is 0, and performs inverse conversion on each bit of the word Wn if the inversion data flag is 1. The inverse conversion corresponds to conversion opposite to conversion during writing. This configuration makes it possible for the controller 30 to correctly return (restore) each bit value of each word W to original values.

These processing steps can be implemented in any of firmware and hardware control.

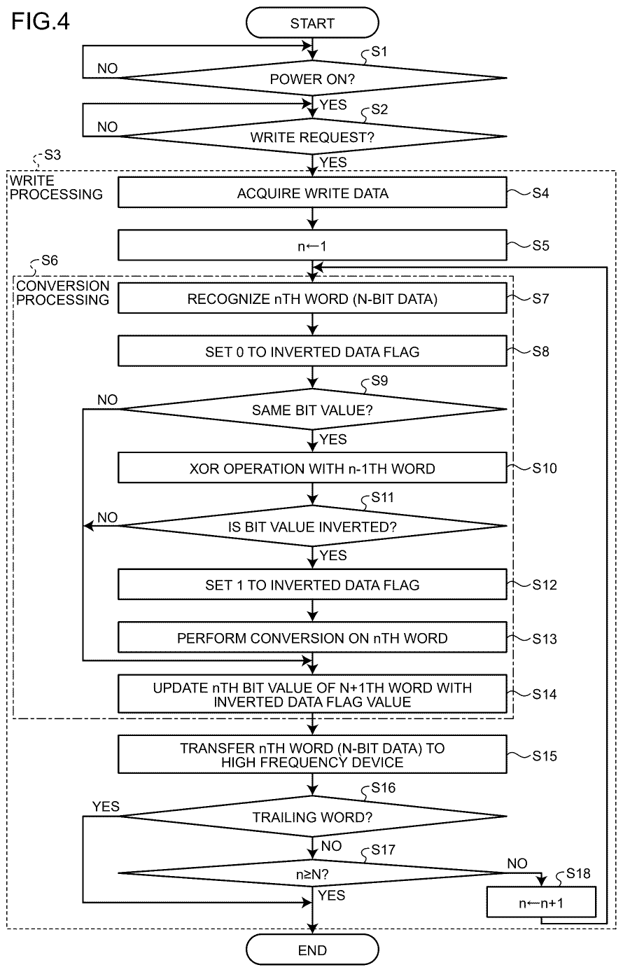

Specifically, the controller 30 may perform an operation as illustrated in FIG. 4. FIG. 4 is a flowchart illustrating detailed operation of the controller 30. FIG. 4 illustrates the operation of the controller 30 related to writing data to the high frequency device 31. FIG. 4 illustrates write data having a length of N words or less. When the write data has a length exceeding N words, the operation illustrated in FIG. 4 may be repeated for each length of N words.

The controller waits until the disk device 1 is activated (No in S1), and when the disk device 1 is activated (Yes in S1), the controller 30 waits until a write request is generated (No in S2). The controller 30 may generate the write request in response to generation of a request for temporarily storage of predetermined data in the high frequency device 31.

When the write request is generated (Yes in S2), the controller 30 performs write processing (S3). The write request includes the write data and specification of a logical address thereof. The specification of the logical address includes specification of a logical address to which the write data is to be written, and includes, for example, a start logical address. In S3, S4 to S6 and S13 to S15 are performed. S6 and S13 to S15 are loop processing.

In the write processing (S3), the controller 30 acquires the write data (S4). The controller 30 is enabled to acquire the write data by extracting the write data from the write request.

When an initial value 1 is set to a parameter n (S5), the controller 30 performs conversion processing (S6). In S6, the controller 30 performs S7 to S14.

In the conversion processing (S6), the controller 30 recognizes the n^{th} word (N-bit data) in the write data (S7). For example, the controller 30 recognizes a start bit of the write data and recognizes a bit position shifted from the position of the start bit by a predetermined number of bits, as the first bit position of the first word. The controller 30 recognizes the bit position serving as a word delimiter, for every N bits from the first bit position of the first word. Therefore, the controller 30 enables an n^{th} word W to be recognized.

The controller 30 sets 0 as the initial value, to the inversion data flag for the n^{th} word W (S8). The value “0” of the inversion data flag indicates invalidity. The invalidity of the inversion data flag includes non-inversion of the bit values in the n^{th} word W, from bit values in an (n−1)^{th} word W.

The controller 30 determines whether the bit values in the n^{th} word W have the same values (S9).

When the bit values in the n^{th} word W have not the same values (No in S9), the controller 30 skips S10 to S13.

When the bit values in the n^{th} word W have the Same values (Yes in S9), the controller 30 performs the XOR operation on the n^{th} word W with the (n−1)^{th} word Wn−1 for each bit (S10).

The controller 30 determines whether the bit values in the n^{th} word W are inverted from the bit values in the (n−1)^{th} word W, according to a result of the XOR operation (S10) for each bit value (S11).

If a result of the XOR operation (S10) for each bit value indicates 0 in at least one bit, the controller 30 determines that the bit values in the n^{th} word W are not inverted from the bit values in the (n−1)^{th} word W (No in S11), and skips S12 and S13.

If all results of the XOR operation (S10) for the bit values indicate 1, the controller 30 determines that the bit values in the n^{th} word W are inverted from the bit values in the (n−1)^{th} word W (Yes in S11), and set 1 to the inversion data flag (S12). The value “1” of the inversion data flag indicates validity. The validity of the inversion data flag includes inversion of the bit values in the n^{th} word W, from the bit values in the (n−1)^{th} word W.

The controller 30 performs, on the n^{th} word Wn, conversion by which the bits of the n^{th} word Wn and the bits of the (n−1)^{th} word Wn−1 have the same values (S13). The controller 30 may perform the 0/1 conversion on the n^{th} word Wn. The controller 30 inverts each bit value of the word Wn and replaces the word Wn in the data with a word Wn after the inversion to perform the 0/1 conversion on the data. Therefore, in the data, each bit value of the n^{th} word Wn and each bit value of the (n−1)^{th} word Wn−1 have the same values.

The controller 30 updates an n^{th} bit value of an (N+1)^{th} word WN+1 for control with a value of the inversion data flag of the n^{th} word Wn (S14).

For example, when Yes is selected in S11 and 1 is set to the inversion data flag in S12, the controller 30 sets 1 to the n^{th} bit value of the (N+1)^{th} word WN+1 serving as a word W for control. Alternatively, when No is selected in S11 and S12 is skipped, the controller 30 sets 0 to the n^{th} bit value of the (N+1)^{th} word WN+1 serving as the word W for control.

When the conversion processing (S6) for the n^{th} word Wn is completed, the controller 30 issues a write command including the n^{th} word Wn, and transfers the write command to the high frequency device 31 (S15).

The controller 30 confirms whether the n^{th} word Wn is a trailing word in the write data (S16). For example, recognition of an end bit of the write data by the controller 30 and the number of bits from the n^{th} word Wn to the position of the end bit being equal to or less than the predetermined number of bits enable the controller 30 to recognize that the n^{th} word Wn is the trailing word.

If the n^{th} word Wn is the trailing word in the write data (Yes in S16), the controller 30 determines that the transfer of all the words included in the write data has been completed, completes the write processing (S3), and finishes the process.

When the n^{th} word Wn is not the trailing word in the write data (No in S16), the controller 30 confirms whether the parameter n has a value having reached N (S17).

If the value of the parameter n has not reached N (No in S17), the controller 30 increments the value of the parameter n (S18), and performs S6, S15, and S16 again.

When the value of the parameter n reaches N (Yes in S17), the controller 30 determines that the transfer of all the words included in the write data has been completed, completes the write processing (S3), and finishes the process.

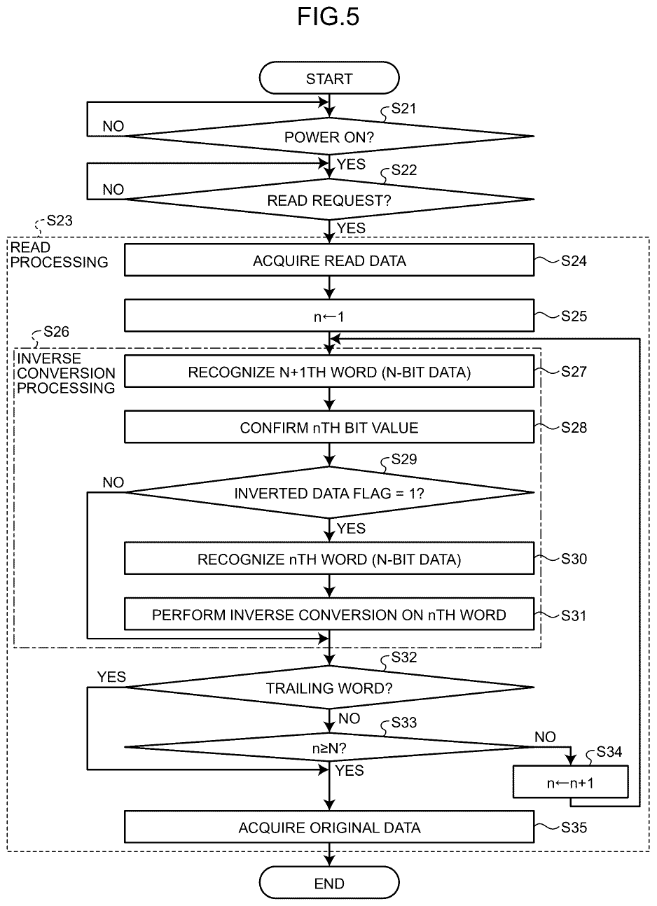

In addition, the controller 30 may perform an operation as illustrated in FIG. 5. FIG. 5 is a flowchart illustrating detailed operation of the controller 30. FIG. 5 illustrates the operation of the controller 30 related to reading data from the high frequency device 31. FIG. 5 illustrates read data having a length of N words or less. When the read data has a length exceeding N words, the operation illustrated in FIG. 5 may be repeated for each length of N words.

The controller waits until the disk device 1 is activated (No in S21), and when the disk device 1 is activated (Yes in S21), the controller 30 waits until a read request is generated (No in S22). The controller 30 may generate the read request in response to generation of a request for reading and referring to data temporarily stored in the high frequency device 31 from the high frequency device 31.

When the read request is generated (Yes in S22), the controller 30 performs read processing (S23). The read request includes specification of a logical address. The specification of the logical address includes specification of a logical address from which data is to be read, and includes, for example, a start logical address. In S23, S24 to S26 and S30 to S32 are performed. S26 and S30 to S32 are loop processing.

In the read processing (S23), the controller 30 acquires the read data (S24). The controller 30 issues a read command according to the read request and supplies the read command to the high frequency device 31. The controller 30 receives a read signal from the high frequency device 31 as a response to the read command, performs equalization processing on the read signal or the like, enabling acquisition of the read data.

When the initial value 1 is set to the parameter n (S25), the controller 30 performs inverse conversion processing (S26). The inverse conversion processing (S26) corresponds inverse conversion of the conversion processing (S6). In S26, the controller 30 performs S27 to S29.

In the inverse conversion processing (S26), the controller 30 recognizes the (N+1)^{th} word (N-bit data) (S27). For example, the controller 30 recognizes the start bit of the write data and recognizes the bit position shifted from the position of the start bit by a predetermined number of bits, as the first bit position of the first word. The controller 30 recognizes the bit position serving as the word delimiter, for every N bits from the first bit position of the first word. Therefore, the controller 30 enables the (N+1)^{th} word WN+1 to be recognized.

The controller 30 confirms the n^{th} bit value in the (N+1)^{th} word WN+1 (S28).

If the n^{th} bit value in the (N+1)^{th} word WN+1 is 0, the controller 30 determines that the value of the inversion data flag of the n^{th} word Wn is 0 (No in S29), and skips S30 and S31.

If the n^{th} bit value in the (N+1)^{th} word WN+1 is 1, the controller 30 determines that the value of the inversion data flag of the n^{th} word Wn is 1 (Yes in S29), and recognizes the n^{th} word (N-bit data) (S30). For example, the controller 30 recognizes the start bit of the write data and recognizes the bit position shifted from the position of the start bit by a predetermined number of bits, as the first bit position of the first word. The controller 30 recognizes the bit position serving as the word delimiter, for every N bits from the first bit position of the first word. Therefore, the controller 30 enables the n^{th} word W to be recognized.

The controller 30 performs inverse conversion on the n^{th} word Wn (S31). The inverse transformation corresponds to inverse conversion of the conversion by which the bits of the n^{th} word Wn and the bits of the (n−1)^{th} word Wn−1 have the same values. The controller 30 may perform the 0/1 conversion on the n^{th} word Wn to perform inverse conversion. The controller 30 inverts each bit value of the word Wn and replaces the word Wn in the data with a word Wn after the inversion to perform the 0/1 conversion on the data. Therefore, each bit value of the n^{th} word Wn in the data is returned to an original value (restored), and the inverse conversion processing (S26) for the n^{th} word Wn is completed.

The controller 30 confirms whether the n^{th} word Wn is a trailing word in the read data (S32). For example, recognition of an end bit of the read data by the controller 30 and the number of bits from the n^{th} word Wn to the position of the end bit being equal to or less than the predetermined number of bits enable the controller 30 to recognize that the n^{th} word Wn is the trailing word.

If the n^{th} word Wn is the trailing word in the read data (Yes in S32), the controller 30 determines that the inverse conversion processing (S26) for all the words included in the read data has been completed, acquires data including the first word W1 to the n^{th} word Wn as original data (S35), and finishes the process.

If the n^{th} word Wn is not the trailing word in the read data (No in S32), the controller 30 confirms whether the value of the parameter n has reached N (S33).

If the value of the parameter n has not reached N (No in S33), the controller 30 increments the value of the parameter n (S34), and performs S26 and S32 again.

When the value of the parameter n reaches N (Yes in S33), the controller 30 determines that the inverse conversion processing (S26) for all the words included in the read data has been completed, acquires data including the first word W1 to the n^{th} word Wn as the original data (S35), and finishes the process.

As described above, in the embodiments, in the disk device 1, when the bit values in the first word having the N-bit width have the same values and the bit values in the second word having the N-bit width, prior to and adjacent to the first word are inverted from the bit values of the first word, the controller 30 performs conversion by which the bit values of the first word and the bit values of the second word have the same values. The conversion by which the bit values of the first word and the bit values of the second word have the same values includes inversion of the bit values of the second word. This configuration enables the controller 30 to sequentially transfer a plurality of words having the same bit values that are not inverted to each other, to the high frequency device 31 via the bus having the N-bit width, suppressing radio wave noise emitted from the bus 32 upon transfer within an allowable range.

Note that the word to be compared for determining whether the bit values are inverted may be a word subsequent to and adjacent to a word of interest, instead of the word prior to and adjacent to the word of interest.

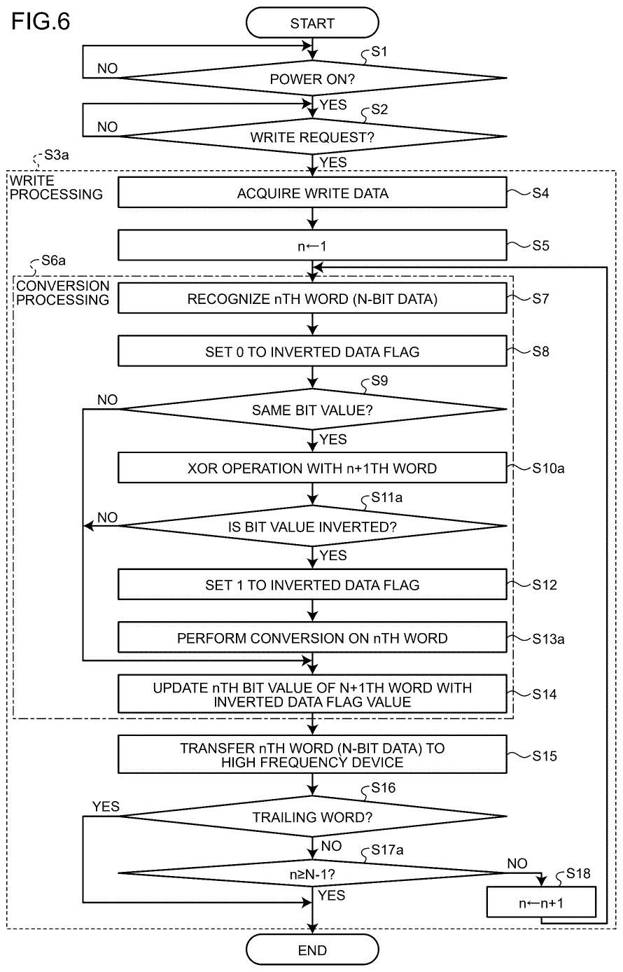

For example, in a first modification of the embodiment, the controller 30 may perform an operation different from that of the embodiment in the following points as illustrated in FIG. 6. FIG. 6 is a flowchart illustrating detailed operation of the controller 30 in the first modification of the embodiment.

After S1 and S2 are performed similarly to the embodiment, write processing (S3a) is performed.

In the write processing (S3a), after S4 and S5 are performed similarly to the embodiment, conversion processing (S6a) is performed.

In the conversion processing (S6a), after S7 and S8 are performed similarly to the embodiment, if the bit values in the n^{th} word W have the same values (Yes in S9), the controller 30 performs the XOR operation on the n^{th} word W with the (n+1)^{th} word Wn+1 for each bit (S10a).

The controller 30 determines whether the bit values in the n^{th} word W are inverted from the bit values in the (n+1)^{th} word W, according to a result of the XOR operation (S10a) for each bit value (S11a).

If a result of the XOR operation (S10a) for each bit value indicates 0 in at least one bit, the controller 30 determines that the bit values in the n^{th} word W are not inverted from the bit values in the (n+1)^{th} word W (No in S11a), and skips S12 and S13.

If all results of the XOR operation (S10a) for the bit values indicate 1, the controller 30 determines that the bit values in the n^{th} word W are inverted from the bit values in the (n+1)^{th} word W (Yes in S11a), and set 1 to the inversion data flag (S12).

The controller 30 performs, on the n^{th} word Wn, conversion by which the bits of the n^{th} word Wn and the bits of the (n+1)^{th} word Wn+1 have the same values (S13a).

The controller 30 may perform the 0/1 conversion on the n^{th} word Wn. The controller 30 inverts each bit value of the word Wn and replaces the word Wn in the data with a word Wn after the inversion to perform the 0/1 conversion on the data. Therefore, in the data, each bit value of the n^{th} word Wn and each bit value of the (n+1)^{th} word Wn+1 have the same values.

Thereafter, when S14 is performed similar to the embodiment and the conversion processing (S6a) is completed, the controller 30 performs S15 and S16 similarly to the embodiment, and confirms whether the value of the parameter n has reached N−1 (S17a).

If the value of the parameter n has not reached N−1 (No in S17a), the controller 30 increments the value of the parameter n (S18), and performs S6a, S15, and S16 again.

When the value of the parameter n reaches N−1 (Yes in S17a), the controller 30 determines that the transfer of all the words included in the write data has been completed, completes the write processing (S3a), and finishes the process.

In this way, in the disk device 1, when the bit values in the first word having the N-bit width have the same values and the bit values in the second word having the N-bit width, subsequent to the first word are inverted from the bit values of the first word, the controller 30 performs conversion by which the bit values of the first word and the bit values of the second word have the same values. This configuration also enables the controller 30 to sequentially transfer a plurality of words having the same bit values that are not inverted to each other, to the high frequency device 31 via the bus having the N-bit width, suppressing radio wave noise emitted from the bus 32 upon transfer within an allowable range.

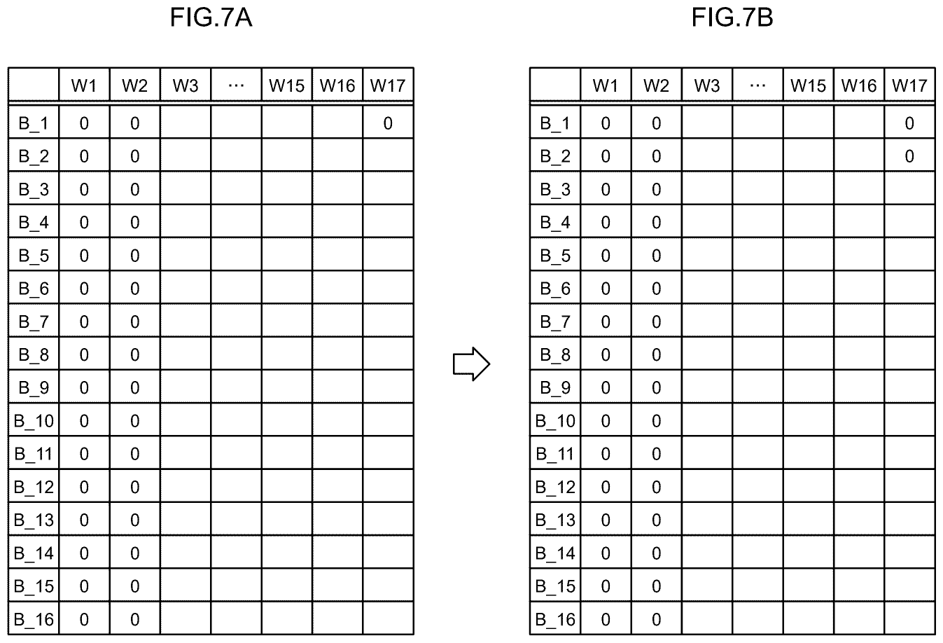

Alternatively, in a second modification of the embodiment, the controller 30 may perform the write processing (S3) as illustrated in FIGS. 7A to 9B. FIGS. 7A to 9B are tables illustrating a use case of the write processing in the second modification of the embodiment. In FIGS. 7A to 9B, the bit width N of the bus 32=16 bits, and one word W includes N=16 bits B_1 to B_16.

In the write processing (S3), when acquiring the write data having a length of 16 words (S4), the controller 30 recognizes the first word W1 in the write data (S7). In the example of FIG. 7A, the word W1 in which all 16 bits B_1 to B_16 are 0 is recognized. An initial value 0 is set to the inversion data flag in the word W1 (S8). Bit values in the first word W1 have the same values (Yes in S9), and the bit values in the first word W1 are not inverted from bit values of a previous word W which is not illustrated (No in S11).

Accordingly, an inversion data flag value is maintained at “0”. As illustrated in FIG. 7A, the value of the first bit B_1 of a word W17 for control is updated with an inversion data flag value “0” (S14).

The second word W2 in the write data is recognized (S7). In the example of FIG. 7A, the word W2 in which all 16 bits B_1 to B_16 are 0 is recognized. The initial value 0 is set to the inversion data flag in the word W2 (S8). Bit values in the second word W2 have the same values (Yes in S9), and the bit values in the second word W2 are not inverted from the bit values of the word W1 previous thereto (No in S11a).

Accordingly, the inversion data flag value is maintained at “0”. As illustrated in FIG. 7B, the value of the second bit B_2 of the word W17 for control is updated with the inversion data flag value “0” (S14).

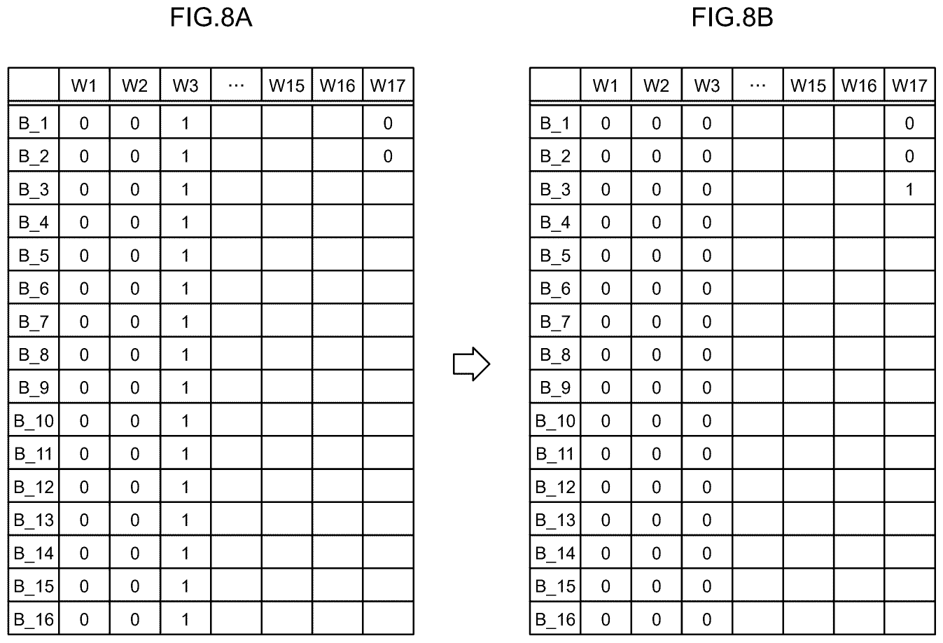

The third word W3 in the write data is recognized (S7). In the example of FIG. 8A, the word W3 in which all 16 bits B_1 to B_16 are 1 is recognized. The initial value 0 is set to the inversion data flag in the word W3 (S8). Bit values in the third word W3 have the same values (Yes in S9), and the bit values in the third word W3 are inverted from the bit values of the word W2 (Yes in S11a).

Accordingly, the inversion data flag value is set to “1” (S12), and conversion by which the bits of the third word W3 and the bits of the word W2 have the same values is performed on the third word W3 (S13a). Therefore, in the data, each bit value of the third word W3 and each bit value of the second word W2 have the same values. As illustrated in FIG. 8B, the value of the third bit B_3 of the word W17 for control is updated with an inversion data flag value “1” (S14).

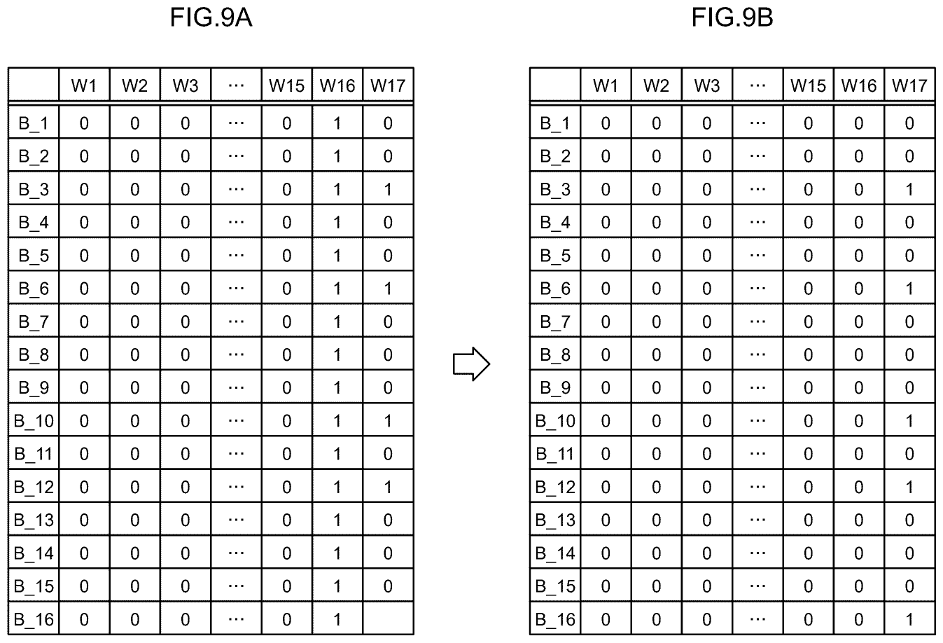

The fifteenth word W15 in the write data is recognized (S7). In the example of FIG. 9A, the word W15 in which all 16 bits B_1 to B_16 are 0 is recognized. The initial value 0 is set to the inversion data flag in the word W15 (S8). Bit values in the fifteenth word W15 have the same values (Yes in S9), and the bit values in the fifteenth word W15 are not inverted from the bit values of a word W14 previous thereto (No in S11a).

Accordingly, the inversion data flag value is maintained at “0”. As illustrated in FIG. 9A, the value of the fifteenth bit B_15 of the word W17 for control is updated with the inversion data flag value “0” (S14).

The sixteenth word W16 in the write data is recognized (S7). In the example of FIG. 9A, the word W16 in which all 16 bits B_1 to B_16 are 1 is recognized. The initial value 0 is set to the inversion data flag in the word W16 (S8). The bit values in the sixteenth word W16 have the same values (Yes in S9), and the bit values in the sixteenth word W16 are inverted from the bit values of the previous word W15 (Yes in S11a).

Accordingly, the inversion data flag value is set to “1” (S12), and conversion by which the bits of the sixteenth word W16 and the bits of the word W15 have the same values is performed on the sixteenth word W16 (S13a). Therefore, in the data, each bit value of the sixteenth word W16 and each bit value of the fifteenth word W15 have the same values. As illustrated in FIG. 9B, the value of the sixteenth bit B_16 of the word W17 for control is updated with the inversion data flag value “1” (S14).

In this way, in the disk device 1, when the bit values in the first word having the N-bit width have the same values and the bit values in the second word having the N-bit width, positioned prior to the first word are inverted from the bit values of the first word, the controller 30 performs conversion by which the bit values of the first word and the bit values of the second word have the same values. This configuration also enables the controller 30 to sequentially transfer a plurality of words having the same bit values that are not inverted to each other, to the high frequency device 31 via the bus having the N-bit width, suppressing radio wave noise emitted from the bus 32 upon transfer within an allowable range.

Furthermore, in the disk device 1, the controller 30 updates the values of the bits B_1 to B_N of the (N+1) th word WN+1 with the inversion data flag values in the first to N^{th} words W1 to WN, respectively. This configuration enables embedding of information about the presence or absence of conversion for the first to N^{th} words W1 to WN, into the word WN+1 for control.

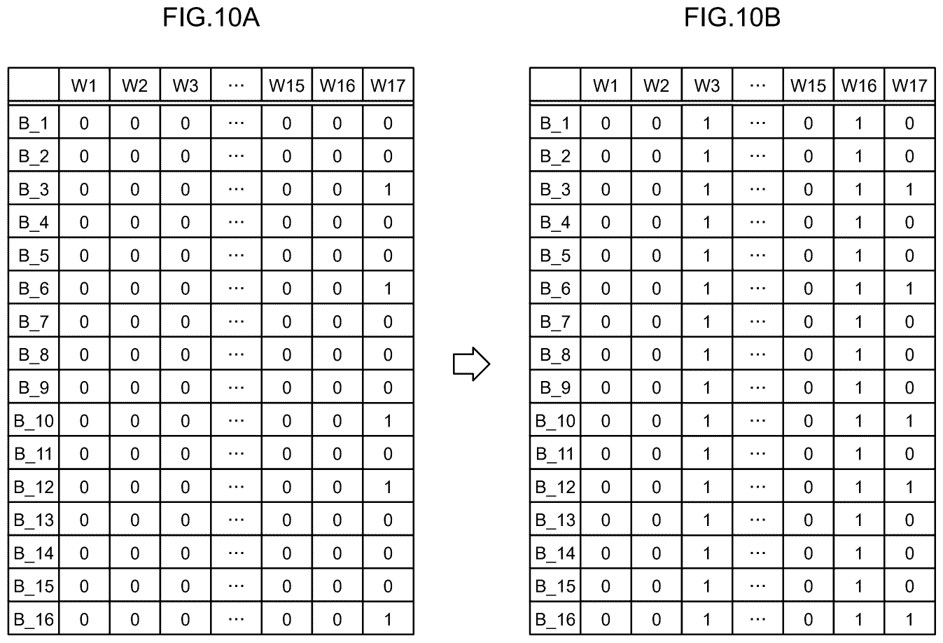

Alternatively, in a third modification of the embodiment, the controller 30 may perform the read processing (S23) as illustrated in FIGS. 10A and 10B. FIGS. 10A and 10B are diagrams illustrating a use case of the read processing in the third modification of the embodiment. In FIGS. 10A and 10B, the bit width N of the bus 32=16 bits, and one word W includes 16 bits B_1 to B_16.

In the read processing (S23), when acquiring the read data having a length of 16 words (S24), the controller 30 recognizes the seventeenth word W17 for control in the read data (S27).

When the controller 30 confirms the first bit value in the seventeenth word W17 (S28), the first bit value is 0 as illustrated in FIG. 10A, and therefore, the controller 30 determines that the value of the inversion data flag in the first word W1 is 0 (No in S29). Accordingly, the controller 30 does not perform inverse conversion (e.g., 0/1 conversion) on the first word W1 as illustrated in FIG. 10B. Therefore, the bits B_1 to B_16 of the first word W1 are maintained at 0.

When the controller 30 confirms the second bit value in the seventeenth word W17 (S28), the bit value is 0 as illustrated in FIG. 10A, and therefore, the controller 30 determines that the value of the inversion data flag in the second word W2 is 0 (No in S29). Accordingly, the controller 30 does not perform inverse conversion (e.g., 0/1 conversion) on the second word W2 as illustrated in FIG. 10B. Therefore, the bits B_1 to B_16 of the second word W2 are maintained at 0.

When the controller 30 confirms the third bit value in the seventeenth word W17 (S28), the bit value is 1 as illustrated in FIG. 10A, and therefore, the controller 30 determines that the value of the inversion data flag in the third word W3 is 1 (Yes in S29). Accordingly, the controller 30 performs inverse conversion (e.g., 0/1 conversion) on the third word W3 as illustrated in FIG. 10B. Therefore, the bits B_1 to B_16 of the third word W3 are changed to 1 and are returned (restored) to the original bit values.

When the controller 30 confirms the fifteenth bit value in the seventeenth word W17 (S28), the bit value is 0 as illustrated in FIG. 10A, and therefore, the controller 30 determines that value of the inversion data flag in the first word W1 is 0 (No in A29). Accordingly, the controller 30 does not perform inverse conversion (e.g., 0/1 conversion) on the fifteenth word W15 as illustrated in FIG. 10B. Therefore, the bits B_1 to B_16 of the fifteenth word W15 are maintained at 0.

When the controller 30 confirms the sixteenth bit value in the seventeenth word W17 (S28), the bit value is 1 as illustrated in FIG. 10A, and therefore, the controller 30 determines that the value of the inversion data flag in the sixteenth word W16 is 1 (Yes in S29). Accordingly, the controller 30 performs inverse conversion (e.g., 0/1 conversion) on the sixteenth word W16 as illustrated in FIG. 10B. Therefore, the bits B_1 to B_16 of the sixteenth word W16 are changed to 1 and are returned (restored) to the original bit values.

In this way, in the disk device 1, the controller 30 confirms the values of the bits B_1 to B_N of the (N+1)^{th} word WN+1, enabling grasping the inversion data flag values in the first to N^{th} words W1 to WN. This configuration makes it possible to identify the presence or absence of conversion for the first to N^{th} words W1 to WN to return (restore) the bit values of the first to N^{th} words W1 to WN to the original values.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a high frequency device;
a bus that is connected to the high frequency device and has an N-bit width where N is an integer of 2 or more; and
a controller that is connected to the high frequency device via the bus,
wherein in data to be transferred to the high frequency device via the bus, when bit values in a first word having an N-bit width have the same values and bit values in a second word having the N-bit width, adjacent to the first word are inverted from the bit values of the first word, the controller performs conversion by which the bit values of the first word and the bit values of the second word have the same values, on the data, and transfers the data subjected to the conversion to the high frequency device via the bus.

2. The disk device according to claim 1, wherein
the controller determines whether the bit values in the second word having the N-bit width, prior to and adjacent to the first word are inverted from the bit values of the first word, according to a result of an exclusive OR operation on the second word prior to and adjacent to the first word with the first word.

3. The disk device according to claim 1, wherein
the controller determines whether the bit values in the second word having the N-bit width, subsequent to and adjacent to the first word are inverted from the bit values of the first word, according to a result of an exclusive OR operation on the second word subsequent to and adjacent to the first word with the first word.

4. The disk device according to claim 2, wherein
the controller determines whether the bit values in the first word have the same values, and when the bit values in the first word have the same values, the controller determines whether the bit values in the second word having the N-bit width, prior to and adjacent to the first word are inverted from the bit values of the first word, according to a result of the exclusive OR operation on the second word prior to and adjacent to the first word with the first word.

5. The disk device according to claim 3, wherein
the controller determines whether the bit values in the first word have the same values, and when the bit values in the first word have the same values, the controller determines whether the bit values in the second word having the N-bit width, subsequent to and adjacent to the first word are inverted from the bit values of the first word, according to a result of the exclusive OR operation on the second word subsequent to and adjacent to the first word with the first word, when the bit values in the first word have the same values.

6. The disk device according to claim 1, wherein
the controller inverts each bit value of the second word and replaces the second word with a word after inversion to perform the conversion on the data.

7. The disk device according to claim 1, wherein
the controller inverts each bit value of the first word and replaces the first word with a word after inversion to perform the conversion on the data.

8. The disk device according to claim 1, wherein
the controller generates a third word having the N-bit width, indicating presence or absence of the conversion for consecutive N words, adds the third word to the data, and transfers the data to the high frequency device.

9. The disk device according to claim 8, wherein
the high frequency device enables data transferred from the controller to be stored, and
the controller performs inverse conversion of the conversion on the second word after the conversion included in the data read from the high frequency device, according to the third word to restore the second word before the returning.

10. The disk device according to claim 1, wherein
the high frequency device includes DRAM accessible in units of 16 bits.

11. A controller comprising:
a communication interface that is connectable to a high frequency device via a bus having an N-bit width where N is an integer of 2 or more; and
a conversion circuit configured to perform a conversion on data to be transferred to the high frequency device via the bus, wherein in the data, when bit values in a first word having the N-bit width are the same, and the same values and bit values in a second word having the N-bit width, subsequent to the first word, are also the same and the same values inverted from the bit values of the first word, the conversion circuit performs a conversion such that the bit values of the first word and the bit values of the second word become the same,
wherein the communication interface is configured to transfer the converted data to the high frequency device via the bus.

12. The controller according to claim 11, wherein
the conversion circuit determines whether the bit values in the second word having the N-bit width, prior to and adjacent to the first word are inverted from the bit values of the first word, according to a result of an exclusive OR operation on the second word prior to and adjacent to the first word with the first word.

13. The controller according to claim 11, wherein
the conversion circuit determines whether the bit values in the second word having the N-bit width, subsequent to and adjacent to the first word are inverted from the bit values of the first word, according to a result of an exclusive OR operation on the second word subsequent to and adjacent to the first word with the first word.

14. The controller according to claim 11, wherein
the conversion circuit inverts each bit value of the second word and replaces the second word with a word after inversion to perform the conversion on the data.

15. The controller according to claim 11, wherein
the conversion circuit inverts each bit value of the first word and replaces the first word with a word after inversion to perform the conversion on the data.

16. A control method comprising:
in a disk device having a high frequency device, in data to be transferred to the high frequency device via a bus having an N-bit width where N is an integer of 2 or more, when bit values in a first word having the N-bit width have the same values and bit values in a second word having the N-bit width, subsequent to the first word have the same values and inverted from the bit values of the first word, performing conversion by which the bit values of the first word and the bit values of the second word have the same values, on the data; and
transferring the data subjected to the conversion, to the high frequency device via the bus.

17. The control method according to claim 16, further comprising
determining whether the bit values in the second word having the N-bit width, prior to and adjacent to the first word are inverted from the bit values of the first word, according to a result of an exclusive OR operation on the second word prior to and adjacent to the first word with the first word.

18. The control method according to claim 16, further comprising
determining whether the bit values in the second word having the N-bit width, subsequent to and adjacent to the first word are inverted from the bit values of the first word, according to a result of an exclusive OR operation on the second word subsequent to and adjacent to the first word with the first word.

19. The control method according to claim 16, wherein
the conversion includes
inverting each bit value of the second word and replacing the second word with a word after inversion.

20. The control method according to claim 16, wherein
the conversion includes
inverting each bit value of the first word and replacing the first word with a word after inversion.
